(19) United States
(12) Patent Application Publication
(10) Pub. No.: US 2026/0008698 A1
(43) Pub. Date: Jan. 8, 2026

(54) METAL COMPOSITE COMPOUND, METHOD FOR PRODUCING METAL COMPOSITE COMPOUND, AND METHOD FOR PRODUCING POSITIVE ELECTRODE ACTIVE MATERIAL FOR LITHIUM SECONDARY BATTERY

(71) Applicant: TANAKA CHEMICAL CORPORATION, Fukui (JP)

(72) Inventors: Ayaka NAKAYA, Fukui-shi (JP); Kimiyasu NAKAO, Fukui-shi (JP); Kenji TAKAMORI, Niihama-shi (JP)

(21) Appl. No.: 18/993,660

(22) PCT Filed: Jul. 14, 2023
(86) PCT No.: PCT/JP2023/026142

§ 371 Date: Jan. 13, 2025

(30) Foreign Application Priority Data
Jul. 15, 2022 (JP) 2022-114295

(51) Int. Cl. C01G 53/84; C01G 53/44; H01M 4/505; H01M 4/525

(52) U.S. Cl. CPC C01G 53/84; C01G 53/44; H01M 4/505; H01M 4/525; C01P 2002/50; C01P 2004/61; C01P 2006/12; C01P 2006/21; C01P 2006/40

(57) ABSTRACT

The present invention relates to a metal composite compound used as a precursor of a positive electrode active material for a lithium secondary battery, said metal composite compound comprising at least one metal element selected from the group consisting of Ni, Co, and Mn, and satisfying all of the following requirements (1) to (3):
(1) An average particle strength is 10 MPa or more and less than 45 MPa;
(2) An average particle diameter D₅₀ is 1.0 μm or more and 4.0 μm or less;
(3) A BET specific surface area is 40 m²/g or more and 100 m²/g or less.

### TECHNICAL FIELD

The present invention relates to a metal composite compound, a method for producing a metal composite compound, and a method for producing a positive electrode active material for a lithium secondary battery.

Priority is claimed on Japanese Patent Application No. 2022-114295, filed Jul. 15, 2022, the content of which is incorporated herein by reference.

### BACKGROUND ART

As a method for producing a positive electrode active material for lithium secondary batteries, for example, there is a method of mixing a lithium compound and a metal composite compound containing a metal element other than Li, followed by calcination.

In order to improve the performance of lithium secondary batteries, the metal composite compound described above has been studied. For example, Patent Document 1 discloses a nickel-manganese-cobalt-containing composite hydroxide composed of secondary particles formed by aggregation of a plurality of plate-shaped primary particles and fine primary particles smaller than the plate-shaped primary particles, as a precursor of a positive electrode active material for lithium ion secondary batteries. It has been disclosed that a lithium ion secondary battery produced using a positive electrode active material for lithium ion secondary batteries having the above nickel-manganese-cobalt-containing composite hydroxide as a precursor exhibits high durability and excellent output characteristics.

### CITATION LIST

### Patent Document

Patent Document 1: Japanese Unexamined Patent Application, First Publication No. 2020-177860

### SUMMARY OF INVENTION

### Technical Problem

As the application fields of lithium secondary batteries develop, further improvements are required for the lithium secondary batteries in the discharge rate characteristics.

The present invention has been made in view of the above circumstances, and aims to provide: a metal composite compound used as a precursor of a positive electrode active material for lithium secondary batteries, from which a lithium secondary battery with high discharge rate characteristics can be obtained; a method for the metal composite compound; and a method for producing a positive electrode active material for a lithium secondary battery using the metal composite compound.

### Solution to Problem

The present invention includes the following [1] to [8].

[1] A metal composite compound used as a precursor of a positive electrode active material for a lithium secondary battery, said metal composite compound including at least one metal element selected from the group consisting of Ni, Co, and Mn, and satisfying all of the following requirements (1) to (3):
(1) An average particle strength is 10 MPa or more and less than 45 MPa:
(2) An average particle diameter D₅₀ is 1.0 μm or more and 4.0 μm or less:
(3) A BET specific surface area is 40 m²/g or more and 100 m²/g or less.

The metal composite compound according to [1], in which said metal composite compound is represented by the following composition formula (I):

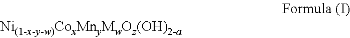

(said composition formula (I) satisfies 0≤x≤0.5, 0≤y≤0.5, 0≤w≤0.15, 0≤x+y+w<1, 0<z≤3, −0.5≤α≤2, and α-z<2, and M is one or more elements selected from the group consisting of Fe, Cu, Ti, Mg, Al, Zn, Sn, Zr, Nb, Ga, W, Mo, B, and Si.)

[3] The metal composite compound according to [1] or [2], which has a standard deviation of particle strength of 1 MPa or more and 9 MPa or less.

[4] The metal composite compound according to any one of [1] to [3], which has a tap density of 0.50 g/cm³ or more and 1.20 g/cm³ or less.

[5] A method for producing a metal composite compound,
the method including
a reaction step of supplying a metal salt solution containing at least one element selected from the group consisting of Ni, Co, and Mn, a complexing agent, and an alkaline solution to a reaction tank to carry out a coprecipitation reaction,
in which in the reaction step, a gas containing oxygen is supplied to a reaction solution in the reaction tank, and an amount (NL) of oxygen consumed with respect to a total amount (mol) of metal elements contained in the metal salt solution is 0.3 NL/mol or more and 0.7 NL/mol or less.

[6] The method for producing a metal composite compound according to [5], in which a reaction temperature in the reaction step is 20° C. or higher and 80° C. or lower.

[7] The method for producing a metal composite compound according to [5] or [6], in which the reaction solution in the reaction tank is stirred with a rotary stirring device in the reaction step, and a stirring power is 1.0 kW/m³ or higher and 4.0 kW/m³ or lower.

[8] A method for producing a positive electrode active material for a lithium secondary battery,
the method including
a mixing step for mixing the metal composite compound of any one of [1] to [4] with a lithium compound, and
a calcination step for calcining the obtained mixture at a temperature of 500° C. or higher and 1,000° C. or lower in an oxygen-containing atmosphere.

### Advantageous Effects of Invention

According to the present invention, it is possible to provide: a metal composite compound used as a precursor of a positive electrode active material for lithium secondary batteries, from which a lithium secondary battery with high discharge rate characteristics can be obtained; a method for producing the metal composite compound; and a method for producing a positive electrode active material for a lithium secondary battery using the metal composite compound.

### BRIEF DESCRIPTION OF DRAWINGS

FIG. 1 A schematic configuration diagram showing an example of a lithium secondary battery.

FIG. 2 A schematic diagram showing an overall structure of an all-solid-state lithium secondary battery.

### DESCRIPTION OF EMBODIMENTS

The definitions of terms used in the present specification are as follows.

A metal composite compound is hereinafter also referred to as “MCC.”

A positive electrode (cathode) active material for lithium secondary batteries is hereinafter also referred to as “CAM.”

“Ni” indicates elemental Ni, not a simple substance of nickel metal. The same applies to the notations of other elements such as Co and Mn.

The term “primary particle” refers to a particle that does not have a grain boundary when observed at a visual field magnification of 10,000 to 30,000 times using a scanning electron microscope or the like.

The term “secondary particle” refers to a particle formed by aggregation of the primary particles. In other words, secondary particles are aggregates of primary particles.

A “metal element” also includes metalloid elements B and Si.

Regarding numerical ranges, “A or more and B or less” is expressed as “A to B”. For example, when a numerical range is described as “1 to 10 MPa,” it means a range from 1 MPa to 10 MPa, and refers to a numerical range including 1 MPa as the lower limit value and 10 MPa as the upper limit value.

The measurement methods for each parameter of the MCC in the present specification are as follows.

### Average Particle Strength

The average particle strength (unit: MPa) of the MCC can be measured and calculated as follows. First, 20 secondary particles are randomly selected from the MCC. Using a microcompression tester (for example, MCT-510 manufactured by Shimadzu Corporation), the particle diameter and particle strength of each of the selected secondary particles are measured. Here, the particle strength Cs (unit: MPa) can be determined by the following formula (A). In the following formula (A), P denotes the test force (unit: N) and d denotes the particle diameter (unit: mm). P is a pressure value at which the displacement becomes maximum while the test pressure remains almost constant when the test pressure is gradually increased. d is a value obtained by measuring the diameters in the X and Y directions in an image observed by the microcompression tester and calculating the average value thereof.

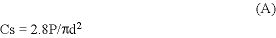

The average value of Cs of the 20 secondary particles obtained is the average particle strength.

Since particle strength is normalized by particle diameter, if the structure of each particle is the same, the particle strength will be the same (average particle strength±5%) even among particles having different particle diameters. On the other hand, if the particle strength differs between particles, it can be said that the structure of each particle is different.

### Standard Deviation of Particle Strength

The standard deviation of the particle strength of the MCC can be calculated from the average particle strength and the Cs of the 20 secondary particles obtained as described above in the section entitled (average particle strength).

### Average Particle Diameter D₅₀

The average particle diameter D₅₀ (unit: μm) of the MCC can be obtained from the particle size distribution of the MCC measured by a laser diffraction scattering method. More specifically, 0.1 g of an MCC powder is added into 50 mL of a 0.2% by mass aqueous solution of sodium hexametaphosphate to obtain a dispersion liquid in which the powder is dispersed. Next, the particle size distribution of the obtained dispersion liquid is measured using a laser diffraction scattering particle size distribution measuring device (for example, Microtrac MT3300EXII manufactured by MicrotracBEL Corporation) to obtain a volume-based cumulative particle size distribution curve. In the obtained cumulative particle size distribution curve, the particle diameter value at 50 cumulative percent from the fine particle side is the average particle diameter (hereinafter, sometimes referred to as D₅₀).

### BET Specific Surface Area

The BET specific surface area (unit: m²/g) of the MCC can be measured by the BET (Brunauer, Emmett, Teller) method. Nitrogen gas is used as an adsorption gas in measuring the BET specific surface area. For example, after drying 1 g of an MCC powder in a nitrogen atmosphere at 105° C. for 30 minutes, measurement can be conducted using a BET specific surface area meter (for example, Macsorb (registered trademark) manufactured by Mountech Co., Ltd.).

### Composition

The composition of each element in MCC can be measured by inductively coupled plasma emission spectrometry (ICP). For example, after dissolving the MCC in hydrochloric acid, the amount of each element can be measured using an inductively coupled plasma optical emission spectrometer (for example, SPS3000, manufactured by SII Nano Technology Inc.).

### Tap Density

The tap density (unit: g/cm³) of the MCC can be measured in accordance with JIS R 1628-1997.

### XRD Pattern

The XRD pattern of the MCC can be obtained by powder X-ray diffraction measurement in which CuKα is used as a radiation source and the measurement range of a diffraction angle 2θ is set in a range of 10 to 90°. For example, an XRD pattern can be obtained for a powder MCC using a powder X-ray diffractometer (for example, Ultima IV, manufactured by Rigaku Corporation). The obtained XRD pattern can be analyzed using analysis software (for example, integrated powder X-ray analysis software PDXL2, manufactured by Rigaku Corporation).

The CAM evaluation method employed in the present specification is as follows.

### Discharge Rate Characteristics

“Discharge rate characteristics” are evaluated as the ratio (5 CA/1 CA discharge capacity ratio) of the discharge capacity at 5 CA to the discharge capacity at 1 CA, which is taken as 100%. The higher this ratio, the higher the battery's output and the better its discharge rate characteristics. In the present specification, the 5 CA/1 CA discharge capacity ratio obtained by performing a discharge rate test under the following conditions using a lithium secondary battery produced using CAM by the following method is used as an index of discharge rate characteristics.

### Production of Positive Electrode for Lithium Secondary Battery

CAM, a conductive material (acetylene black), and a binder (PVdF) are added and kneaded so as to obtain a composition of CAM:conductive material:binder=92:5:3 (mass ratio) to prepare a paste-like positive electrode mixture. N-methyl-2-pyrrolidone is used as an organic solvent at the time of preparing the positive electrode mixture.

The obtained positive electrode mixture is applied to a 40 μm thick Al foil that serves as a current collector and vacuum dried at 150° C. for 8 hours to obtain a positive electrode for a lithium secondary battery. The electrode area of this positive electrode for a lithium secondary battery is set to 1.65 cm².

### Production of Lithium Secondary Battery

The following operations are performed in a glove box with an argon atmosphere.

The above-mentioned positive electrode for a lithium secondary battery is placed on a lower lid of a part for a coin-type battery R2032 (manufactured by Hohsen Corporation) with the aluminum foil surface facing down, and a laminate film separator (thickness: 16 μm) obtained by laminating a heat-resistant porous layer on a porous film made of polyethylene is placed thereon. 300 μl of an electrolytic solution is injected thereinto. As the electrolytic solution, a liquid obtained by dissolving LiPF₆ at a ratio of 1.0 mol/l in a mixed solution obtained by mixing ethylene carbonate, dimethyl carbonate, and ethyl methyl carbonate at a ratio of 30:35:35 (volume ratio) is used.

Next, metallic lithium used as a negative electrode is placed on the upper side of the separator, covered with a top lid through a gasket, and swaged using a swage, thereby producing a lithium secondary battery.

### Discharge Rate Test

Test temperature: 25° C.
Maximum charge voltage 4.3V, charge current 1 CA, constant current constant voltage charge/
Minimum discharge voltage 2.5V, discharge current 1 CA or 5 CA, constant current discharge/
Using the discharge capacity when discharged at a constant current of 1 CA and the discharge capacity when discharged at a constant current of 5 CA, calculate the 5 CA/1 CA discharge capacity ratio using the following formula.

### 5 CA/1 CA Discharge Capacity Ratio

$$( 5 CA / 1 CA discharge capacity ratio )$$

$$5 CA / 1 CA discharge capacity ratio ( \% ) = discharge capacity at 5 CA / discharge capacity at 1 CA \times 100 \qquad ( formula )$$

### Metal Composite Compound

The MCC of the present embodiment can be used as a precursor of CAM. MCC contains at least one metal element selected from the group consisting of Ni, Co, and Mn, and satisfies all of the following requirements (1) to (3).
(1) The average particle strength is 10 MPa or more and less than 45 MPa.
(2) The average particle diameter D₅₀ is from 1.0 to 4.0 μm.
(3) The BET specific surface area is from 40 to 100 m²/g.

The MCC is an aggregate of a plurality of particles. In other words, the MCC is in a powder form. The MCC may contain only secondary particles, or may be a mixture of primary particles and secondary particles. In addition, the MCC is preferably a metal composite hydroxide, a metal composite oxide, or a mixture thereof. In the present specification, the term “metal composite hydroxide” also includes a substance in which a part of the metal composite hydroxide is oxidized.

### Requirement (1)

The average particle strength of the MCC is preferably 15 MPa or more, and more preferably 25 MPa or more. The average particle strength is preferably 40 MPa or less.

The above lower limit values and upper limit values can be arbitrarily combined.

The average particle strength is preferably from 15 to 40 MPa, and more preferably from 25 to 40 MPa. When the average particle strength is within the above range, the reactivity of the lithium compound during the production of the CAM is increased, the abnormal growth of the primary particles of the CAM is suppressed, and the decrease in the BET specific surface area of the CAM is suppressed. As a result, an increase in the interfacial resistance on the surface of the CAM particles is suppressed, and the discharge rate characteristics of the resulting lithium secondary battery are likely to be improved.

An MCC that satisfies the requirement (1) is an MCC with low particle strength. It is considered that particle strength is determined by a plurality of factors related to the aggregation state of primary particles, such as the density of primary particles in the secondary particles, the orientation of primary particles, the contact area between primary particles, and the strength of adhesion between primary particles. Further, the above factors are also influenced by the characteristics derived from the primary particles, such as the size and shape of the primary particles. For example, it is considered that even among the MCC in which the density of primary particles in the secondary particles is low, depending on the other factors described above, the average particle strength of the MCC will be 45 MPa or more, which does not satisfy the above requirement (1).

A preferred example of the primary particles that constitute the secondary particles of an MCC that satisfies the requirement (1) and the aggregation state of the primary particles in the secondary particles is described below.

As the primary particles, fully grown primary particles having an anisotropic shape are preferred. The phrase “anisotropic shape” refers to a shape having an aspect ratio of 1.5 or more, which is the ratio of the major axis with respect to the minor axis of the primary particles. The aspect ratio means the ratio of the length (major axis) with respect to the breadth (minor axis) of a rectangle that circumscribes the primary particle and has the smallest area. Examples of anisotropic shapes include rod-like shapes and plate-like shapes. When the primary particles grow sufficiently, the primary particles become relatively large. Large primary particles have a smaller external surface area per unit volume than small primary particles. Therefore, it is considered that the contact area between large primary particles is more likely to be smaller than that of small primary particles when the primary particles aggregate. In addition, it is considered that when the primary particles have an anisotropic shape, the density of the primary particles in the secondary particles is lower than that of primary particles having an isotropic shape. The phrase “isotropic shape” refers to a shape in which the aspect ratio of the primary particles is less than 1.5. Examples of isotropic shapes include regular polyhedron shapes, spherical shapes, and nearly spherical shapes.

When 20 primary particles randomly selected from the secondary particles are observed under a scanning electron microscope, the proportion of primary particles having an aspect ratio of 1.5 or more is preferably from 20 to 100%, more preferably from 30 to 95%, and still more preferably from 40 to 90%.

The average particle diameter of the primary particles in the secondary particles is preferably from 20 to 1,500 nm, more preferably from 50 to 1,400 nm, and still more preferably from 100 to 1,000 nm. The particle diameter of the primary particles means the average of the minor and major axes of the primary particles when the primary particles are observed under a scanning electron microscope. The average of particle diameters of 20 primary particles randomly selected from one secondary particle can be taken as the average particle diameter of the primary particles.

The aggregation state of primary particles in the secondary particles is preferably such that the density of the primary particles is low, the contact area between the primary particles is small, and the strength of adhesion between the primary particles is small. Such secondary particles tend to have low particle strength and are likely to satisfy the above requirement (1).

In addition, with regard to the aggregation state of primary particles in the secondary particles, the primary particles are preferably oriented in a uniform manner. In such a case, adjacent primary particles slide against each other, and the secondary particles tend to crack. Therefore, such secondary particles tend to have low particle strength and are likely to satisfy the above requirement (1).

The primary particles and the aggregation state of the primary particles in the secondary particles can be confirmed by observation with a scanning electron microscope.

### Requirement (2)

D₅₀ of the MCC is preferably 1.5 μm or more, and more preferably 2.0 μm or more. The D₅₀ is preferably from 1.5 to 4.0 μm, and more preferably from 2.0 to 4.0 μm. When D₅₀ is equal to or greater than the lower limit of the range, the BET specific surface area of the resulting CAM is not too large, and gas generation due to a side reaction with the electrolyte is suppressed. When D₅₀ is equal to or less than the upper limit of the range, the BET specific surface area of the resulting CAM is not too small, and an increase in the interface resistance of the CAM particle surface is suppressed, and the discharge rate characteristics of the resulting lithium secondary battery are likely to be improved.

### Requirement (3)

The BET specific surface area of the MCC is preferably 41 m²/g or more, and more preferably 42 m²/g or more. The BET specific surface area is preferably 90 m²/g or less, and more preferably 80 m²/g or less.

The above lower limit values and upper limit values of the BET specific surface area can be arbitrarily combined.

The BET specific surface area is preferably from 41 to 90 m²/g, and more preferably from 42 to 80 m²/g. When the BET specific surface area is equal to or greater than the lower limit, an increase in the interfacial resistance of the surface of the resulting CAM particles is suppressed, and the discharge rate characteristics of the resulting lithium secondary battery are likely to be improved. When the BET specific surface area is equal to or less than the upper limit, gas generation due to a side reaction between the resulting CAM and the electrolyte can be suppressed.

In addition to the above requirements (1) to (3), the MCC preferably satisfies the following physical properties.

The standard deviation of particle strength of the MCC is preferably 1 MPa or more, more preferably 1.0 MPa or more, still more preferably 3.0 MPa or more, and particularly preferably 5.0 MPa or more. The standard deviation of particle strength is preferably 9 MPa or less, more preferably 9.0 MPa or less, and still more preferably 8.9 MPa or less.

The above lower limit values and upper limit values can be arbitrarily combined.

The standard deviation of particle strength is preferably from 1 to 9 MPa, more preferably from 1.0 to 9.0 MPa, still more preferably from 3.0 to 8.9 MPa, and particularly preferably 5.0 to 8.9 MPa. When the standard deviation of particle strength is equal to or greater than the lower limit of the range, particle cracking due to contact between particles is unlikely to occur, and handling properties are likely to be improved. When the standard deviation of the particle strength is equal to or less than the upper limit, the uniformity of the MCC is increased, and the cycle characteristics and discharge rate characteristics of a battery using the obtained CAM are likely to be improved.

The tap density of the MCC is preferably 0.50 g/cm³ or more, more preferably 0.60 g/cm³ or more, and still more preferably 0.65 g/cm³ or more. The tap density is preferably 1.20 g/cm³ or less, more preferably 1.10 g/cm³ or less, and still more preferably 1.00 g/cm³ or less.

The above lower limit values and upper limit values of the tap density can be arbitrarily combined.

The tap density is preferably from 0.50 to 1.20 g/cm³, more preferably from 0.60 to 1.10 g/cm³, and still more preferably from 0.65 to 1.00 g/cm³. When the tap density is equal to or greater than the lower limit, the BET specific surface area of the resulting CAM is not too large, and gas generation due to a side reaction with the electrolyte can be suppressed. When the tap density is equal to or less than the upper limit, the BET specific surface area of the resulting CAM is not too small, and an increase in the interface resistance of the CAM particle surface is suppressed, and the discharge rate characteristics of the resulting lithium secondary battery are likely to be improved.

From the viewpoint of facilitating the reaction during the production of CAM, the layered structure, more preferably belonging to crystal structure of MCC is preferably a any one of hexagonal, orthorhombic and monoclinic crystal systems, and still more preferably belonging to hexagonal crystal systems.

The MCC preferably has a low degree of crystallinity. In the XRD pattern of the MCC, the ratio of the half-width of the peak observed in the range of 2θ=19.2±1° to the half-width of the peak observed in the range of 2θ=38.5±1° is preferably 0.10 or more, more preferably 0.20 or more, still more preferably 0.30 or more, and particularly preferably more than 0.30. The half-width ratio is preferably 1.00 or less, more preferably 0.90 or less, still more preferably 0.80 or less, and particularly preferably 0.70 or less. The half-width ratio is preferably 0.10 to 1.00, more preferably 0.20 to 0.90, still more preferably 0.30 to 0.80, and particularly preferably more than 0.30 and 0.70 or less.

### Composition

The MCC contains at least one metal element selected from the group consisting of Ni, Co, and Mn. The MCC preferably contains Ni, more preferably contains Ni and at least one metal element selected from the group consisting of Co and Mn, and still more preferably contains Ni, Co, and Mn. The MCC does not substantially contain Li. The above expression “does not substantially contain Li” means that the ratio of the number of moles of Li with respect to the total number of moles of Ni, Co, and Mn in the MCC is 0.1 or less.

### Composition Formula

The MCC is preferably represented by the following composition formula (I).

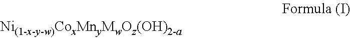

The above composition formula (I) satisfies 0≤x≤0.5, 0≤y≤0.5, 0≤w≤0.15, 0≤x+y+w≤1, 0<z≤3, −0.5≤α≤2, and α-z<2, and M is one or more elements selected from the group consisting of Fe, Cu, Ti, Mg, Al, Zn, Sn, Zr, Nb, Ga, W, Mo, B, and Si.

The MCC is preferably a hydroxide represented by the following composition formula (I)-1.

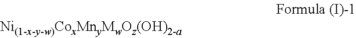

The above composition formula (I)-1 satisfies 0≤x≤0.5, 0≤y≤0.5, 0≤w≤0.15, 0≤x+y+w<1, 0<z≤3, and −0.5≤α<2, and M is one or more elements selected from the group consisting of Fe, Cu, Ti, Mg, Al, Zn, Sn, Zr, Nb, Ga, W, Mo, B, and Si.

When w is greater than 0, from the viewpoint that the cycle characteristics and discharge rate characteristics of a battery using the obtained CAM are likely to be improved, M is preferably one or more elements selected from the group consisting of Ti, Mg, Al, Zr, Nb, W, Mo, B, and Si, and more preferably one or more elements selected from the group consisting of Al, Zr, Nb, and W.

x is preferably 0.01 or more, more preferably 0.02 or more, and still more preferably 0.03 or more.

x is preferably 0.44 or less, more preferably 0.42 or less, and still more preferably 0.40 or less.

The above upper limit values and lower limit values of x can be arbitrarily combined.

The above composition formula (I) or the above composition formula (I)-1 preferably satisfies 0.01≤x≤0.44, more preferably satisfies 0.02≤x≤0.42, and still more preferably satisfies 0.03≤x≤0.40.

y is preferably 0.01 or more, more preferably 0.02 or more, and still more preferably 0.03 or more.

y is preferably 0.44 or less, more preferably 0.42 or less, and still more preferably 0.40 or less.

The above upper limit values and lower limit values of y can be arbitrarily combined.

The above composition formula (I) or the above composition formula (I)-1 preferably satisfies 0.01≤y≤0.44, more preferably satisfies 0.02≤y≤0.42, and still more preferably satisfies 0.03≤y≤0.40.

w is preferably 0.001 or more, more preferably 0.0015 or more, and still more preferably 0.002 or more.

w is preferably 0.12 or less, more preferably 0.10 or less, still more preferably 0.08 or less, and particularly preferably 0.05 or less. In one embodiment of the present invention, w is preferably 0.

The above upper limit values and lower limit values of w can be arbitrarily combined.

When w exceeds 0, the above composition formula (I) or the above composition formula (I)-1 preferably satisfies 0.001≤w≤0.12, more preferably satisfies 0.0015≤w≤0.10, still more preferably satisfies 0.002≤w≤0.08, and particularly preferably satisfies 0.002≤w≤0.05.

x+y+w is preferably 0.1 or more, more preferably 0.2 or more, still more preferably 0.3 or more, and particularly preferably more than 0.5.

x+y+w is preferably 0.9 or less, more preferably 0.8 or less, and still more preferably 0.7 or less.

The above upper limit values and lower limit values of x+y+w can be arbitrarily combined.

The above composition formula (I) or the above composition formula (I)-1 preferably satisfies 0.1≤x+y+w≤0.9, more preferably satisfies 0.2≤x+y+w≤0.8, still more preferably satisfies 0.3≤x+y+w≤0.7, and particularly preferably 0.5<x+y+w≤0.7.

z is preferably 0.02 or more, more preferably 0.03 or more, and still more preferably 0.05 or more.

z is preferably 2.8 or less, more preferably 2.6 or less, and still more preferably 2.4 or less.

The above upper limit values and lower limit values of z can be arbitrarily combined.

The above composition formula (I) and the above composition formula (I)-1 preferably satisfies 0<z≤2.8, more preferably satisfies 0.02≤z≤2.8, still more preferably satisfies 0.03≤z≤2.6, and particularly preferably satisfies 0.05≤z≤2.4.

In one aspect of the present invention, the composition formula (I) and the above composition formula (I)-1 preferably satisfies 0<z≤0.5, more preferably satisfies 0.02≤z≤0.3, still more preferably satisfies 0.03≤z≤0.2, and particularly preferably satisfies 0.05≤z≤0.15.

α is preferably −0.45 or more, more preferably −0.40 or more, and still more preferably −0.35 or more.

α is preferably 1.8 or less, more preferably 1.6 or less, and still more preferably 1.4 or less. The above upper limit values and lower limit values of a can be arbitrarily combined.

The above composition formula (I) or the above composition formula (I)-1 preferably satisfies −0.45≤α≤1.8, more preferably satisfies −0.40≤α≤1.6, and still more preferably satisfies −0.35≤α≤1.4.

The above composition formula (I) or the above composition formula (I)-1 preferably satisfies 0.01≤x≤0.44, 0.01≤y≤0.44, 0.001≤w≤0.12, 0.1≤x+y+w≤0.9, 0<z≤2.8, and −0.45≤α≤1.8.

### Method for Producing Metal Composite Compound

The method for producing MCC includes a reaction step in which a metal salt solution containing at least one element selected from the group consisting of Ni, Co, and Mn, a complexing agent, and an alkaline solution are supplied to a reaction tank to carry out a coprecipitation reaction.

In the reaction step, a gas containing oxygen is supplied to a reaction solution in the reaction tank, and the amount (NL) of oxygen consumed with respect to the total amount (mol) of metal elements contained in the metal salt solution is 0.3 to 0.7 NL/mol. “NL” refers to the amount (L) of oxygen consumed converted to standard conditions.

When the metal salt solution, the complexing agent, and the alkaline solution are subjected to a coprecipitation reaction, the resulting MCC becomes a metal composite hydroxide. The metal composite hydroxide can be produced by a batch-type coprecipitation method or a continuous-type coprecipitation method.

In the reaction step, the metal composite hydroxide produced by the coprecipitation reaction reacts with oxygen supplied to the reaction solution in the reaction tank, and part of the metal composite hydroxide is oxidized. It is known that primary particles of metal composite hydroxide generally grow into plates and become densely packed together, however when the primary particles grow while part of the metal composite hydroxide is oxidized, the primary particles are less likely to grow.

In other words, MCC produced by a production method including a reaction step is more likely to have an anisotropic shape. Furthermore, when the primary particles have an anisotropic shape, it is believed that the density of the primary particles in the secondary particles is lower compared to primary particles having an isotropic shape. As a result, MCC is more likely to satisfy requirement (1). Furthermore, the discharge rate characteristics can be improved.

The amount (hereinafter also referred to as “O₂/Me”) of oxygen consumed with respect to the total amount of metal elements contained in the above-mentioned metal salt solution is preferably 0.3 NL/mol or more, more preferably 0.35 NL/mol or more, and still more preferably 0.38 NL/mol or more. O₂/Me is preferably 0.7 NL/mol or less, more preferably 0.65 NL/mol or less, and still more preferably 0.60 NL/mol or less.

The lower limit and upper limit values of O₂/Me can be arbitrarily combined.

O₂/Me is more preferably from 0.35 to 0.65 NL/mol, and still more preferably from 0.38 to 0.60 NL/mol.

When O₂/Me is equal to or greater than the above-mentioned lower limit, a portion of the metal composite hydroxide is more likely to be oxidized, and the primary particles are more likely to have an anisotropic shape, and due to the above-mentioned effects, MCC is more likely to satisfy requirement (1). In addition, MCC is more likely to satisfy requirement (3). As a result, the discharge rate characteristics can be improved. When O₂/Me is equal to or less than the upper limit, the BET specific surface area of the resulting CAM does not become too large, and gas generation due to a side reaction with the electrolyte can be suppressed.

### O₂/Me Measurement

The method for measuring O₂/Me in either the batch coprecipitation method or the continuous coprecipitation method is as follows.

In the case of the batch coprecipitation method, a metal salt solution, a complexing agent, and an alkaline solution are charged into a batch reactor, and a reaction is carried out while circulating a gas containing oxygen. In addition, an alkaline solution is appropriately dropped to adjust the pH after the reaction starts. The total amount (mol) of metal elements contained in the metal salt solution charged into the batch reactor is calculated. The supply rate (supplied O₂) (NL/min) of oxygen in the oxygen-containing gas is also calculated. Furthermore, the exhaust rate (exhausted O₂) (NL/min) of oxygen in the gas exhausted from the reaction tank is calculated. The supply O₂ minus exhaust O₂ is calculated to obtain the oxygen consumption rate (NL/min). The oxygen consumption rate is then multiplied by the reaction time (min) to obtain the amount (NL) of oxygen consumed. The obtained amount of oxygen consumed is then divided by the total amount of metal elements contained in the above-mentioned metal salt solution to obtain O₂/Me.

In the case of the continuous coprecipitation method, a metal salt solution, a complexing agent, an alkaline solution, and an oxygen-containing gas are continuously supplied to a reaction tank, and the reaction is carried out in a continuous manner. The supply rate (mol/min) of the total amount of metal elements contained in the metal salt solution is calculated. Also, the supply rate (supplied O₂) (NL/min) of oxygen in the oxygen-containing gas is calculated. Furthermore, the exhaust rate (exhausted O₂) (NL/min) of oxygen in the gas exhausted from the reaction tank is calculated. Supply O₂—exhaust O₂ is calculated to obtain the oxygen consumption rate (NL/min). Then, O₂/Me can be calculated by dividing the obtained oxygen consumption rate by the supply rate of the total amount of metal elements contained in the above-mentioned metal salt solution.

The analysis of the amount of oxygen to determine the above-mentioned supply O₂ and exhaust O₂ can be performed using, for example, a low-concentration oxygen concentration analyzer (PS-800-L) manufactured by Iijima Electronics Co., Ltd.

Hereinafter, a method for producing an MCC containing Ni, Co, and Mn using a continuous co-precipitation method will be described as an example. More specifically, a nickel salt solution, a cobalt salt solution, a manganese salt solution, a complexing agent, and an alkaline solution are reacted by the continuous coprecipitation method described in Japanese Unexamined Patent Application, First Publication No. 2002-201028 to produce a metal composite hydroxide represented by Ni_{(1-x′-y′)}Co_{x′}Mn_{y′}(OH)₂. For example, when producing an MCC represented by the above composition formula (I) and the above composition formula (I)-1, x′ and y′ correspond to x and y in the above composition formula (I) and the above composition formula (I)-1, respectively.

As a nickel salt serving as a solute of the nickel salt solution, for example, at least one of nickel sulfate, nickel nitrate, nickel chloride, and nickel acetate can be used.

As a cobalt salt serving as a solute of the cobalt salt solution, for example, at least one of cobalt sulfate, cobalt nitrate, cobalt chloride, and cobalt acetate can be used.

As a manganese salt serving as a solute of the manganese salt solution, for example, at least one of manganese sulfate, manganese nitrate, manganese chloride, and manganese acetate can be used.

It should be noted that even when producing a MCC containing a metal element other than Ni, Co, and Mn, a sulfate, nitrate, chloride, or acetate of this metal element can be used as the solute.

The metal salt is used in a ratio corresponding to the composition ratio of the above Ni_{(1-x′-y′)}Co_{x′}Mn_{y′}(OH)₂. That is, the amount of each metal salt is specified so that the molar ratio of Ni, Co, and Mn in a mixed solution containing the above metal salts corresponds to (1-x′-y′): x′:y′ in the above composition formula. Further, water is used as a solvent.

The complexing agent is capable of forming a complex with nickel ions, cobalt ions, and manganese ions in an aqueous solution, examples thereof include ammonium ion donors such as ammonium chloride, ammonium carbonate, ammonium hydroxide, ammonium sulfate, and ammonium fluoride, hydrazine, ethylenediaminetetraacetic acid, nitrilotriacetic acid, uracildiacetic acid, and glycine, and ammonium ion donors are preferred.

The amount of the complexing agent contained in a mix solution containing the nickel salt solution, cobalt salt solution, manganese salt solution, and complexing agent is preferably such that, for example, the molar ratio with respect to the total number of moles of the metal salts (nickel salt, cobalt salt, and manganese salt) is greater than 0 and equal to or less than 2.0.

When an ammonium ion donor is used as the complexing agent, the ammonia concentration with respect to the total volume of the solution in the reaction tank is preferably from 1.0 to 3.0 g/L, and more preferably from 1.5 to 2.5 g/L. When the ammonia concentration is within the above range, the requirements (2) and (3) are satisfied, and preferably, an MCC having a tap density within the above range is easily obtained.

In the coprecipitation method, in order to adjust the pH value of the mixed solution containing the nickel salt solution, cobalt salt solution, manganese salt solution, and complexing agent, an alkaline solution is added to the mixed solution before the pH of the mixed solution changes from alkaline to neutral. Examples of the alkaline solution include an aqueous solution of an alkali metal hydroxide. Further, examples of the alkali metal hydroxide include sodium hydroxide and potassium hydroxide.

It should be noted that the pH value in the present specification is defined as a value measured when the temperature of the mixed solution is 40° C. The pH of the mixed solution is measured when the temperature of the mixed solution sampled from the reaction tank reaches 40° C. When the sampled mixed solution is not at 40° C., the mixed solution is heated or cooled to 40° C. and the pH is measured.

When the complexing agent are continuously supplied to the reaction tank in addition to the above nickel salt solution, cobalt salt solution, manganese salt solution, Ni, Co, and Mn react to produce Ni_{(1-x′-y′)}Co_{x′}Mn_{y′}(OH)₂.

The reaction temperature is preferably 20° C. or more, more preferably 30° C. or more, and still more preferably 40° C. or more. The reaction temperature is preferably 80° C. or less, more preferably 70° C. or less, and still more preferably 60° C. or less.

The above lower and upper limits of the reaction temperature can be combined in any combination.

The reaction temperature is preferably from 20 to 80° C., more preferably from 30 to 70° C., and sill more preferably 40 to 60° C. When the reaction temperature is equal to or higher than the lower limit, the primary particles tend to grow sufficiently. Also, the reaction between the metal composite hydroxide and oxygen tends to proceed easily. When the reaction temperature is equal to or lower than the upper limit, oxygen tends to dissolve in the reaction solution in the reaction tank.

In other words, when the reaction temperature is within the above range, a portion of the metal composite hydroxide tends to be oxidized, and the primary particles tend to have an anisotropic shape, and due to the above-mentioned effect, the MCC tends to satisfy requirement (1). Also, when the reaction temperature is within the above range, an MCC having a tap density within the above-mentioned range is easily obtained. Further the discharge rate characteristics can be improved.

The pH value of the mixed solution in the reaction tank is preferably 9.0 or more, more preferably 10.0 or more, and still more preferably 11.0 or more. The pH value is preferably 13.0 or less, more preferably 12.7 or less, and still more preferably 12.4 or less.

The above lower and upper limits of the pH can be combined in any combination.

The pH value is preferably from 9.0 to 13, more preferably from 10.0 to 12.7, and still more preferably from 11.0 to 12.4. When the pH value is within the above range, it is easy to obtain an MCC that satisfies requirement (2) and preferably has a tap density within the above range. Furthermore, the discharge rate characteristics can be improved.

The reaction precipitate formed in the reaction tank is neutralized while being stirred. The time for neutralizing the reaction precipitate is, for example, from 1 to 20 hours.

Stirring is preferably performed with a rotary stirrer having stirring blades. Stirring makes it easier for oxygen to be taken up into the reaction solution in the reaction tank.

The stirring power is preferably 1.0 kW/m³ or more, more preferably 1.3 kW/m³ or more, and still more preferably 1.6 kW/m³ or more. The stirring power is preferably 4.0 kW/m³ or less, more preferably 3.0 kW/m³ or less, and still more preferably 2.5 kW/m³ or less. The lower limit values and upper limit values of the stirring power can be combined arbitrarily.

The stirring power is preferably 1.0 to 4.0 kW/m³, more preferably 1.3 to 3.0 kW/m³, and still more preferably 1.6 to 2.5 kW/m³. When the stirring power is within the above range, oxygen is more easily taken up by the reaction solution in the reaction tank. As a result, a part of the metal composite hydroxide is easily oxidized, and the primary particles are easily formed in an anisotropic shape, and the above-mentioned effects make it easier for the MCC to satisfy the requirement (1). As a result, the discharge rate characteristics can be improved.

As the reaction tank used in a continuous-type coprecipitation method, a type of reaction tank that overflows can be used in order to separate the formed reaction precipitate.

When producing a metal composite hydroxide by a batch-type coprecipitation method, examples of the reaction tank include a reaction tank without an overflow pipe, and a device to an overflow pipe and having a mechanism equipped with a concentration tank connected by which the overflowed reaction precipitate is concentrated in the concentration tank and circulated once again to the reaction tank.

As described above, a gas containing oxygen gas is supplied to the reaction solution in the reaction tank. The amount of oxygen with respect to the total volume of the gas is preferably from 10 to 100% by volume, and more preferably from 15 to 90% by volume. Examples of gases other than oxygen in the gas include inert gases such as nitrogen, argon, and carbon dioxide. Air can be used as the gas containing oxygen. The gas containing oxygen is preferably supplied by bubbling it into the reaction solution in the reaction tank.

The above-mentioned O₂/Me, reaction temperature, and stirring rotation speed greatly affect the particle strength of the resulting MCC. For this reason, it is preferable to appropriately adjust various conditions to obtain an MCC that satisfies the above-mentioned requirement (1) and preferably has a standard deviation of particle strength within the above-mentioned range.

In the present embodiment, it is preferable to set O₂/Me to from 0.3 to 0.7 NL/mol, the reaction temperature to from 20 to 80° C., and the stirring power to from 1.0 to 4.0 kW/m³, and it is more preferable to set O₂/Me to from 0.35 to 0.65 NL/mol, the reaction temperature to from 30 to 70° C., and the stirring power to 1.0 to 4.0 kW/m².

By setting such reaction conditions, it becomes easier to obtain an MCC that satisfies the above-mentioned requirement (1) and preferably has a standard deviation of particle strength within the above-mentioned range.

After the above reaction, the neutralized reaction precipitate is washed with water and then isolated. For the isolation, for example, a method of dehydrating a slurry containing the reaction precipitate (that is, a coprecipitated slurry) by centrifugation, suction filtration or the like is used.

The isolated reaction precipitate is washed, dehydrated, dried, and sieved as necessary to obtain a metal composite hydroxide containing Ni, Co, and Mn.

The reaction precipitate is preferably washed with water, weak acid water, or an alkaline cleaning solution. In the present embodiment, washing with an alkaline cleaning solution is preferred, and washing with an aqueous sodium hydroxide solution or an aqueous potassium hydroxide solution is more preferred.

It is preferable to wash with water, weak acid water, or an alkaline cleaning solution in a mass of 10 times or more the mass of the reaction precipitate. In addition, the temperature of the water, weak acid water, or alkaline cleaning solution used is preferably 30° C. or higher. Furthermore, it is preferable to perform washing one or more times.

It should be noted that after washing with a solution other than water, it is preferable to further wash with water so that compounds derived from the solution do not remain in the reaction precipitate.

The drying temperature is preferably from 80 to 250° C., and more preferably from 90 to 230° C. The drying time is preferably from 0.5 to 30 hours, and more preferably from 1 to 25 hours. The drying pressure may be normal pressure or reduced pressure.

When producing a metal composite oxide as MCC, a metal composite hydroxide may be heated to produce a metal composite oxide. If necessary, a plurality of heating steps may be performed. In the present specification, the heating temperature means the set temperature of a heating device. In the case of including a plurality of heating steps, it means the temperature when heating is performed at the maximum holding temperature in each heating step.

The heating temperature is preferably from 400 to 700° C., and more preferably from 450 to 680° C. When the heating temperature is from 400 to 700° C., the metal composite hydroxide is sufficiently oxidized, and a metal composite oxide having a BET specific surface area within an appropriate range is obtained.

The time for holding the above heating temperature may be from 0.1 to 20 hours, and is preferably from 0.5 to 10 hours. The rate of temperature increase to the above heating temperature is, for example, from 50 to 400° C./hour. Further, as the heating atmosphere, air, oxygen, nitrogen, argon, or a mixed gas thereof can be used.

The inside of the heating device may be under an appropriate oxygen-containing atmosphere. The oxygen-containing atmosphere may be a mixed gas atmosphere of an inert gas and an oxidizing gas, or may be a state in which an oxidizing agent is present under an inert gas atmosphere. By having an appropriate oxygen-containing atmosphere inside the heating device, a transition metal contained in the metal composite hydroxide is appropriately oxidized, making it easier to control the form of the metal composite oxide.

As the oxygen or oxidizing agent in the oxygen-containing atmosphere, a sufficient number of oxygen atoms need to be present in order to oxidize the transition metal.

When the oxygen-containing atmosphere is a mixed gas atmosphere of an inert gas and an oxidizing gas, the atmosphere in the heating device can be controlled by a method of allowing the oxidizing gas to pass through the heating device, bubbling the oxidizing gas into the mixed solution, or the like.

As the oxidizing agent, peroxides such as hydrogen peroxide, peroxide salts such as permanganates, perchlorates, hypochlorites, nitric acid, halogens, ozone, and the like can be used.

By heating the metal composite hydroxide obtained by the above-mentioned reaction steps under the above-mentioned conditions, a metal composite oxide that satisfies the requirements (1) to (3) can be obtained.

By the steps described above, an MCC can be produced.

### Method for Producing Positive Electrode Active Material for Lithium Secondary Battery

The method for producing CAM of the present embodiment includes a mixing step for mixing an MCC with a lithium compound, and a calcination step for calcining the obtained mixture at a temperature of 500 to 1,000° C. in an oxygen-containing atmosphere. CAM can be produced by the above method.

The above-mentioned MCC is used in the method for producing CAM.

### Mixing Step

The MCC and a lithium compound are mixed.

As the above lithium compound, at least any one of lithium carbonate, lithium nitrate, lithium acetate, lithium hydroxide (hydrates included), lithium oxide, lithium chloride, and lithium fluoride can be used. Among these, any one of lithium hydroxide and lithium carbonate, or a mixture thereof is preferred. Further, when the raw material (reagent or the like) containing lithium hydroxide contains lithium carbonate, the content of lithium carbonate in the lithium hydroxide is preferably 5% by mass or less.

The lithium compound and the MCC are mixed in consideration of the composition ratio of the final target product, thereby obtaining a mixture of the lithium compound and the MCC. The amount of Li with respect to the total amount (taken as 1) of metal elements contained in the MCC (molar ratio) is preferably from 0.98 to 1.20, more preferably from 1.04 to 1.18, and particularly preferably from 1.05 to 1.17.

### Calcination Step

The obtained mixture is calcined at a calcination temperature of 500 to 1,000° C. in an oxygen-containing atmosphere. By calcining the mixture, CAM crystals grow.

The calcination temperature in the present specification refers to the temperature of the atmosphere in the calcination device, and means the maximum temperature of the holding temperature (maximum holding temperature).

When the calcination step includes a plurality of calcination stages, the calcination temperature means the temperature when calcining at the maximum holding temperature in each calcination stage.

The calcination temperature is preferably from 700 to 1000° C., more preferably from 750 to 970° C., and still more preferably from 800° C. to 950° C. When the calcination temperature is equal to or higher than the lower limit value of the above range, a CAM having a strong crystal structure can be obtained. Further, when the calcination temperature is equal to or lower than the upper limit value of the above range, the volatilization of lithium ions on the particle surface of the CAM can be reduced.

The retention time in the calcination step is preferably from 3 to 50 hours, and more preferably from 4 to 20 hours. When the retention time in the calcination step is equal to or less than the upper limit value of the above range, the volatilization of lithium ions is suppressed, and the deterioration in battery performance is suppressed. When the retention time in the calcination step is equal to or more than the lower limit value of the above range, the development of crystals is promoted, and the deterioration in battery performance is suppressed.

In the calcination step, the rate of temperature increase until reaching the maximum holding temperature is preferably 80° C./hour or more, more preferably 100° C./hour or more, and still more preferably 150° C./hour or more. The rate of temperature increase until reaching the maximum holding temperature is calculated from the time ranging from the start of temperature increase up to a point reaching the holding temperature in the calcination device.

The calcination step preferably includes a plurality of calcination stages with different calcination temperatures. For example, it is preferable to include a first calcination stage and a second calcination stage in which calcination is performed at a higher temperature than that in the first calcination stage. Calcination stages with different calcination temperatures and calcination times may be further included.

Depending on the desired composition, as the calcination atmosphere, air, oxygen, nitrogen, argon, a mixed gas thereof or the like is used. The calcination atmosphere is preferably an oxygen-containing atmosphere.

The mixture of the MCC and the lithium compound may be calcined in the presence of an inert melting agent. The inert melting agent is added to such an extent that the initial capacity of the battery using the CAM is not impaired, and may remain in the calcination product. As the inert melting agent, for example, the inert melting agent described in WO 2019/177032A1 can be used.

The calcination device used at the time of calcination is not particularly limited, and may be, for example, a continuous calcination furnace or a fluidized calcination furnace. Examples of the continuous calcination furnace include a tunnel furnace and a roller hearth kiln. As a fluidized calcination furnace, a rotary kiln may be used.

CAM is obtained by calcining the mixture of the MCC and the lithium compound as described above. It should be noted that after calcination, washing with water and drying may be performed as appropriate.

### Lithium Secondary Battery

A suitable positive electrode for a lithium secondary battery when the CAM produced by the production method of the present embodiment is used will be described. Hereinafter, the positive electrode for a lithium secondary battery may be referred to as the positive electrode.

Furthermore, a lithium secondary battery as a suitable use of a positive electrode will be described.

An example of a suitable lithium secondary battery when using the CAM produced by the production method of the present embodiment includes a positive electrode and a negative electrode, a separator sandwiched between the positive electrode and the negative electrode, and an electrolytic solution disposed between the positive electrode and the negative electrode.

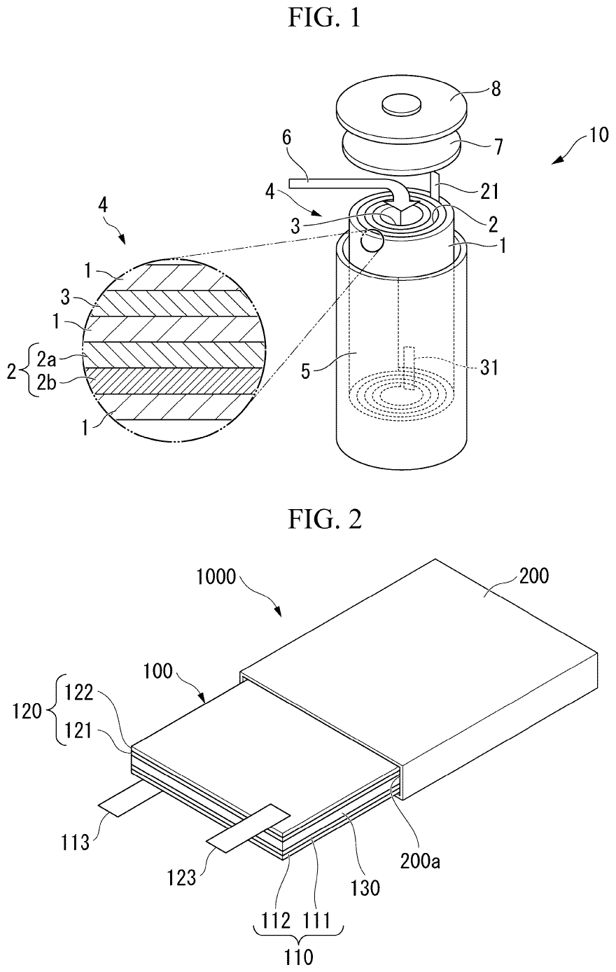

FIG. 1 is a schematic diagram showing an example of a lithium secondary battery. For example, a cylindrical lithium secondary battery 10 is produced as follows.

First, as shown in the partially enlarged view of FIG. 1, a pair of separators 1 having a strip shape, a strip-shaped positive electrode 2 having a positive electrode lead 21 at one end, and a strip-shaped negative electrode 3 having a negative electrode lead 31 at one end are laminated in an order of the separator 1, the positive electrode 2, the separator 1, and the negative electrode 3, and are wound to form an electrode group 4.

The positive electrode 2 includes, as an example, a positive electrode active material layer 2a containing CAM, and a positive electrode current collector 2b in which the positive electrode active material layer 2a is formed on one side. This type of positive electrode 2 can be produced by first preparing a positive electrode mixture containing CAM, a conductive material, and a binder, and then supporting the positive electrode mixture on one side of the positive electrode current collector 2b to form the positive electrode active material layer 2a.

Examples of the negative electrode 3 include an electrode in which a negative electrode mixture containing a negative electrode active material (not shown) is supported on a negative electrode current collector, and an electrode composed solely of a negative electrode active material, and can be produced in the same manner as that applied for the positive electrode 2.

Subsequently, after accommodating the electrode group 4 and an insulator (not shown) in a battery can 5, the bottom of the can is sealed, and the electrode group 4 is impregnated with an electrolytic solution 6 such that an electrolyte is disposed between the positive electrode 2 and the negative electrode 3. Furthermore, by sealing an upper portion of the battery can 5 with a top insulator 7 and a sealing body 8, the lithium secondary battery 10 can be produced.

Examples of the shape of the electrode group 4 include a columnar shape so that the cross-sectional shape when the electrode group 4 is cut in the direction perpendicular to the winding axis is a circle, an ellipse, a rectangle, or a rectangle with rounded corners.

Further, as the shape of the lithium secondary battery having such an electrode group 4, the shape prescribed by IEC60086, which is a standard for batteries prescribed by the International Electrotechnical Commission (IEC), or by JIS C 8500 can be adopted. Examples thereof include a cylindrical shape, a square shape and the like.

Furthermore, the lithium secondary battery is not limited to the wound type configuration as described above, and may have a laminated type configuration in which a laminated structure of a positive electrode, a separator, a negative electrode and a separator is repeatedly overlaid. Examples of the laminated type lithium secondary battery include the so-called coin type batteries, button type batteries, and paper type (or sheet type) batteries.

For the positive electrode, separator, negative electrode, and electrolytic solution that constitute the lithium secondary battery, for example, the configuration, materials, and production method described in sections [0113] to [0140] in WO 2022/113904A1 can be used.

### All-Solid-State Lithium Secondary Battery

The CAM produced by the production method of the present embodiment can be used for an all-solid-state lithium secondary battery.

FIG. 2 is a schematic diagram showing an example of an all-solid-state lithium secondary battery. An all-solid-state lithium secondary battery 1,000 shown in FIG. 2 includes a laminate 100 having a positive electrode 110, a negative electrode 120 and a solid electrolyte layer 130, and an exterior body 200 accommodating the laminate 100. Further, the all-solid-state lithium secondary battery 1,000 may have a bipolar structure in which a CAM and a negative electrode active material are arranged on both sides of a current collector. Specific examples of the bipolar structure include structures described in JP-A-2004-95400.

The positive electrode 110 has a positive electrode active material layer 111 and a positive electrode current collector 112. The positive electrode active material layer 111 contains the above-mentioned CAM and a solid electrolyte. Further, the positive electrode active material layer 111 may contain a conductive material and a binder.

The negative electrode 120 has a negative electrode active material layer 121 and a negative electrode current collector 122. The negative electrode active material layer 121 contains a negative electrode active material. Further, the negative electrode active material layer 121 may contain a solid electrolyte and a conductive material.

The laminate 100 may have an external terminal 113 connected to the positive electrode current collector 112 and an external terminal 123 connected to the negative electrode current collector 122. In addition, the all-solid-state lithium secondary battery 1,000 may have a separator between the positive electrode 110 and the negative electrode 120.

The all-solid-state lithium secondary battery 1,000 further has an insulator (not shown) that insulates the laminate 100 from the exterior body 200, and a sealing body (not shown) that seals an opening 200a of the exterior body 200.

As the exterior body 200, a container obtained by molding a metal material having high corrosion resistance such as aluminum, stainless steel or nickel-plated steel can be used. In addition, as the exterior body 200, a container obtained by processing a laminate film having at least one surface subjected to a corrosion resistant treatment into a bag shape can also be used.

Examples of the shape of the all-solid-state lithium secondary battery 1,000 include shapes such as a coin type, a button type, a paper type (or a sheet type), a cylindrical type, a square type, and a laminate type (pouch type).

Although a form of the all-solid-state lithium secondary battery 1,000 having one laminate 100 is illustrated as an example, the present embodiment is not limited thereto. The all-solid-state lithium secondary battery 1,000 may have a configuration in which the laminate 100 serves as a unit cell and a plurality of unit cells (laminates 100) are sealed inside the exterior body 200.

For the all-solid-state lithium secondary battery, for example, the configuration, materials, and production method described in sections [0141] to [0181] in WO 2022/113904A1 can be used.

The present invention further includes the following aspects [11] to [20].

[11] A MCC used as a precursor of a CAM, the MCC including at least one metal element selected from the group consisting of Ni, Co, and Mn, and satisfying all of the following requirements (1)-1 to (3)-1:
(1)-1 An average particle strength is from 25 to 40 MPa;
(2)-1 D₅₀ is from 2.0 to 4.0 μm;
(3)-1 A BET specific surface area is from 42 to 80 m²/g.

[12] The MCC according to [11], in which the MCC is represented by the above composition formula (I).

[13] The MCC according to [11] or [12], which has a standard deviation of particle strength of 3.0 MPa or more and 8.9 MPa or less.

[14] The MCC according to any one of [11] to [13], which has a tap density of 0.65 g/cm³ or more and 1.00 g/cm³ or less.

[15] The MCC according to any one of [11] to [14], which has a standard deviation of particle strength of 5.0 MPa or more and 8.9 MPa or less.

[16] The MCC according to any one of [11] to [15], in which the MCC is represented by the above composition formula (I)-1.

[17] A method for producing a MCC,
the method including
a reaction step of supplying a metal salt solution containing at least one element selected from the group consisting of Ni, Co, and Mn, a complexing agent, and an alkaline solution to a reaction tank to carry out a coprecipitation reaction,
wherein in the reaction step, a gas containing oxygen is supplied to a reaction solution in the reaction tank, the above O₂/Me is from 0.38 to 0.60 NL/mol.

[18] The method for producing a MCC according to [17], wherein a reaction temperature in the reaction step is from 40 to 60° C.

[19] The method for producing a MCC according to [17] or [18], in which the reaction solution in the reaction tank is stirred with a rotary stirring device in the reaction step, and a stirring power is from 1.6 to 2.5 kW/m³.

[20] A method for producing a CAM,
the method including
a mixing step for mixing the MCC of any one of [11] to [16] with a lithium compound, and
a calcination step for calcining the obtained mixture at a temperature of from 500 to 1,000° C. in an oxygen-containing atmosphere.

### EXAMPLES

The present invention will be described in more detail below with reference to Examples, but the present invention is not limited thereto.

### Measurement of Various Parameters of MCC

Measurements of various parameters of an MCC produced by the method described below were performed using the measurement methods and the like as described above in the sections entitled (average particle strength), (standard deviation of particle strength), (average particle diameter D₅₀), (composition), (BET specific surface area), and (tap density).

### O₂/Me Measurement

The O₂/Me ratio in the method described below was determined by the method described above (O₂/Me measurement).

### Measurement of 5 CA/1 CA Discharge Capacity Ratio

The 5 CA/1 CA discharge capacity ratio of a lithium secondary battery was measured using the measurement method described above in (Discharge rate characteristics). When the 5 CA/1 CA discharge capacity ratio is 90% or higher, the discharge rate characteristics are evaluated as high. In Table 1, the 5 CA/1 CA discharge capacity ratio is represented as “5 C”.

### Example 1

After pouring water into a reaction tank equipped with a rotary stirring device having a stirring blade and an overflow pipe, an aqueous sodium hydroxide solution was added thereto, and the liquid temperature (reaction temperature) was maintained at 50° C.

An aqueous nickel sulfate solution, an aqueous cobalt sulfate solution, an aqueous manganese sulfate solution, and aqueous zirconium sulfate solution were mixed so that the molar ratio of Ni:Co:Mn:Zr was 33.8:35.8:29.9:0.5 to prepare a mixed raw material solution 1.

The mixed raw material solution 1 and an aqueous ammonium sulfate solution as a complexing agent were continuously added into a reaction tank while stirring under continuous supply of oxygen-containing gas. An aqueous sodium hydroxide solution was added dropwise at appropriate times so that the pH of the solution in the reaction tank became 12.20 (measurement temperature: 40° C.), and the rate of dropwise addition of the aqueous ammonium sulfate solution was adjusted so that the ammonia concentration became 2.0 g/L, thereby obtaining a reaction precipitate 1. It should be noted that the stirring power was 2.2 kW/m³ and O₂/Me was 0.54 NL/mol.

The reaction precipitate 1 was washed using an aqueous sodium hydroxide solution (sodium hydroxide concentration: 5% by mass) in a mass 20 times the mass of the reaction precipitate 1. After washing, it was dehydrated using a filter press, washed with water, dehydrated, and dried at 105° C. for 20 hours to obtain a metal composite hydroxide 1 containing Ni, Co, Mn, and Zr. Various parameters of metal composite hydroxide 1 are shown in Table 1 (the same applies to Examples 2 and 3, and Comparative Examples 1 and 2 below). It should be noted that 1-x-y-w, x, y, and w in the composition column in Table 1 are values corresponding to those in the composition formula (I)-1 described above.

Lithium carbonate was weighed out so that the amount of Li (molar ratio) with respect to the total amount (taken as 1) of Ni, Co, Mn, and Zr contained in the metal composite hydroxide 1 was 1.17. The metal composite hydroxide 1 and the lithium carbonate were mixed to obtain a mixture 1.

Then, the obtained mixture 1 was calcined at 920° C. for 5 hours in an air atmosphere to obtain a powder 1. The obtained powder 1 was mixed with pure water adjusted to a liquid temperature of 5° C. so that the mass ratio of the above powder 1 with respect to the total amount was 0.3 to prepare a slurry. The slurry was stirred for 20 minutes, then dehydrated, and further rinsed with pure water adjusted to a liquid temperature of 5° C. in an amount twice the mass of the above powder 1, followed by isolation and drying at 150° C. to obtain a CAM 1.

A lithium secondary battery was produced using the obtained CAM 1, and the 5 CA/1 CA discharge capacity ratio was measured. The results are shown in Table 1 (the same applies to Examples 2 and 3, and Comparative Examples 1 and 2 below).

### Example 2

A metal composite hydroxide 2 and a CAM 2 were obtained in the same manner as in Example 1, except that the stirring power was set to 1.8 kW/m³ and O₂/Me was set to 0.47 NL/mol.

### Example 3

After pouring water into a reaction tank equipped with a rotary stirring device having a stirring blade and an overflow pipe, an aqueous sodium hydroxide solution was added thereto, and the liquid temperature (reaction temperature) was maintained at 50° C.

An aqueous nickel sulfate solution, an aqueous cobalt sulfate solution, and an aqueous manganese sulfate solution were mixed so that the molar ratio of Ni:Co:Mn was 31.5:33:35.5 to prepare a mixed raw material solution 3.

The mixed raw material solution 3 and an aqueous ammonium sulfate solution as a complexing agent were continuously added into a reaction tank while stirring under continuous supply of oxygen-containing gas. An aqueous sodium hydroxide solution was added dropwise at appropriate times so that the pH of the solution in the reaction tank became 12.20 (measurement temperature: 40° C.), and the rate of dropwise addition of the aqueous ammonium sulfate solution was adjusted so that the ammonia concentration became 2.0 g/L, thereby obtaining a reaction precipitate 3. It should be noted that the stirring power was 1.8 kW/m³ and O₂/Me was 0.39 NL/mol.

The same procedure as in Example 1 was carried out except that reaction precipitate 3 was used, to obtain a metal composite hydroxide 3 and a CAM 3.

### Comparative Example 1

A metal composite hydroxide 4 and a CAM 4 were obtained in the same manner as in Example 1, except that the stirring power was set to 1.5 kW/m³ and O₂/Me was set to 0.15 NL/mol.

### Comparative Example 2

After pouring water into a reaction tank equipped with a rotary stirring device having a stirring blade and an overflow pipe, an aqueous sodium hydroxide solution was added thereto, and the liquid temperature (reaction temperature) was maintained at 50° C.

An aqueous nickel sulfate solution, an aqueous cobalt sulfate solution, an aqueous manganese sulfate solution, and aqueous zirconium sulfate solution were mixed so that the molar ratio of Ni:Co:Mn:Zr was 33.8:35.8:29.9:0.5 to prepare a mixed raw material solution 5.

The mixed raw material solution 5 and an aqueous ammonium sulfate solution as a complexing agent were continuously added into a reaction tank while stirring under a nitrogen flow. An aqueous sodium hydroxide solution was added dropwise at appropriate times so that the pH of the solution in the reaction tank became 12.20 (measurement temperature: 40° C.), and the rate of dropwise addition of the aqueous ammonium sulfate solution was adjusted so that the ammonia concentration became 2.0 g/L, thereby obtaining a reaction precipitate 5. It should be noted that the stirring power was 1.5 kW/m³.

The same procedure as in Example 1 was carried out except that the reaction precipitate 5 was used, to obtain a metal composite hydroxide 5 and a CAM 5.

TABLE 1

| | Parameters of MCC | | | | | | | | | | | |
|---|---|---|---|---|---|---|---|---|---|---|---|---|
| | | | | | | Average | Particle strength | | BET | | | |
| | | | | | | particle | Average | | specific | | | Battery |
| | Composition | | | | | diameter | particle | Standard | surface | Tap | Half-width | characteristics |
| | Ni | Co | Mn | M | Type | D₅₀ | strength | deviation | area | density | ratio | 5 C |
| | 1-x-y-w | x | y | w | of M | [μm] | [MPa] | [MPa] | [m²/g] | [g/cm³] | (19.2 ± 1°)/(38.5 ± 1°) | [%] |
| Ex. 1 | 0.338 | 0.358 | 0.299 | 0.005 | Zr | 2.4 | 34.3 | 6.4 | 70.4 | 0.81 | 0.46 | 90.2 |
| Ex. 2 | 0.338 | 0.358 | 0.299 | 0.005 | Zr | 3.4 | 37.3 | 3.7 | 61.1 | 0.67 | 0.58 | 90.2 |
| Ex. 3 | 0.315 | 0.330 | 0.355 | 0 | — | 4.0 | 40.3 | 8.9 | 42.7 | 0.89 | 0.33 | 90.3 |
| Comp. Ex. 1 | 0.338 | 0.358 | 0.299 | 0.005 | Zr | 2.5 | 60.4 | 13.1 | 40.9 | 1.01 | 0.30 | 86.0 |
| Comp. Ex. 2 | 0.338 | 0.358 | 0.299 | 0.005 | Zr | 2.7 | 47.1 | 6.6 | 13.8 | 1.35 | 0.24 | 85.5 |

It was found that the lithium secondary batteries produced using the CAM having MCC as a precursors in Examples 1 to 3, which satisfy the requirements (1) to (3) had a high discharge rate characteristics.

### REFERENCE SIGNS LIST

1: Separator; 2: Positive electrode; 2a: Positive electrode active material layer; 2b: Positive electrode current collector; 3: Negative electrode; 4: Electrode group; 5: Battery can; 6: Electrolytic solution; 7: Top insulator; 8: Sealing body; 10: Lithium secondary battery; 21: Positive electrode lead; 31: Negative electrode lead; 100: Laminate; 110: Positive electrode; 111: Positive electrode active material layer; 112: Positive electrode current collector; 113: External terminal; 120: Negative electrode; 121: Negative electrode active material layer; 122: Negative electrode current collector; 123: External terminal; 130: Solid electrolyte layer; 200: Exterior body; 200a: Opening; 1000: All-solid-state lithium secondary battery

1. A metal composite compound used as a precursor of a positive electrode active material for a lithium secondary battery, said metal composite compound comprising at least one metal element selected from the group consisting of Ni, Co, and Mn, and satisfying all of the following requirements (1) to (3):
(1) An average particle strength is 10 MPa or more and less than 45 MPa;
(2) An average particle diameter D₅₀ is 1.0 μm or more and 4.0 μm or less;
(3) A BET specific surface area is 40 m²/g or more and 100 m²/g or less.

2. The metal composite compound according to claim 1, wherein said metal composite compound is represented by the following composition formula (I): 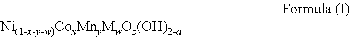
(said composition formula (I) satisfies 0≤x≤0.5, 0≤y≤0.5, 0≤w≤0.15, 0≤x+y+w<1, 0<z≤3, −0.5≤α≤2, and α-z <2, and M is one or more elements selected from the group consisting of Fe, Cu, Ti, Mg, Al, Zn, Sn, Zr, Nb, Ga, W, Mo, B, and Si.)

3. The metal composite compound according to claim 1, which has a standard deviation of particle strength of 1 MPa or more and 9 MPa or less.

4. The metal composite compound according to claim 1, which has a tap density of 0.50 g/cm³ or more and 1.20 g/cm³ or less.

5. A method for producing a metal composite compound,
the method comprising
a reaction step of supplying a metal salt solution containing at least one element selected from the group consisting of Ni, Co, and Mn, a complexing agent, and an alkaline solution to a reaction tank to carry out a coprecipitation reaction,
wherein in the reaction step, a gas containing oxygen is supplied to a reaction solution in the reaction tank, and an amount (NL) of oxygen consumed with respect to a total amount (mol) of metal elements contained in the metal salt solution is 0.3 NL/mol or more and 0.7 NL/mol or less.

6. The method for producing a metal composite compound according to claim 5, wherein a reaction temperature in the reaction step is 20° C. or higher and 80° C. or lower.

7. The method for producing a metal composite compound according to claim 5, wherein the reaction solution in the reaction tank is stirred with a rotary stirring device in the reaction step, and a stirring power is 1.0 kW/m³ or higher and 4.0 kW/m³ or lower.

8. A method for producing a positive electrode active material for a lithium secondary battery,
the method comprising
a mixing step for mixing the metal composite compound of claim 1 with a lithium compound, and
a calcination step for calcining the obtained mixture at a temperature of 500° C. or higher and 1,000° C. or lower in an oxygen-containing atmosphere.
